(19) United States
(12) Patent Application Publication
(10) Pub. No.: US 2026/0152154 A1
(43) Pub. Date: Jun. 4, 2026

(54) SELF-AWARE TOWING SYSTEM AND METHOD FOR IMPLEMENTING SAME

(71) Applicant: HL MANDO CORPORATION, Gyeonggi-do (KR)

(72) Inventors: Aniket KUMAR, Bay City, MI (US); Bryan FREED, Bay City, MI (US)

(21) Appl. No.: 18/965,924

(22) Filed: Dec. 2, 2024

(51) Int. Cl. B60T 8/17; B60T 8/172

(52) U.S. Cl. CPC B60T 8/1708; B60T 8/172; B60T 2230/06

(57) ABSTRACT

A trailer to be towed by a vehicle is provided. The trailer includes: at least two road wheels; and at least one electro-mechanical braking (EMB) unit attached to one of the at least two road wheels. The at least one EMB unit is coupled to a processor with a memory, the processor being part of a centralized EMB controller configured to control the EMB unit, and the memory stores instructions that when executed by the processor causes the at least one EMB unit to perform operations for controlling lateral motion of the trailer. The operations include: obtaining first braking instructions from a chassis controller of the vehicle, the first braking instructions being based on a current operating state of the at least one EMB unit determined by the chassis controller; and performing the first braking instructions.

### BACKGROUND

Various embodiments of the present disclosure relate in general to towed and/or towing system, and more particularly, to systems and components of towed vehicles and/or other structures.

Motor vehicles (also referred to herein as simply “vehicles”) are adapted to be able to tow another structure (e.g., another vehicle, a trailer, a cargo bed with wheels, or the like). The structure being towed (referred to herein generically as a “trailer”) may not have all of the capabilities of the vehicle towing the structure. For example, a trailer being towed by a truck may not have its own motor, steering, and/or embedded computer for controlling the mechanical, electrical, and/or electro-mechanical components installed on the trailer.

As a result, such trailers may not have the capability to instantly adapt to environmental hazards and/or happenings as the vehicle doing the towing, which may lead to dangerous conditions for the vehicle performing the towing. Such trailers may also not have the capability to alert the vehicle performing the towing of such environmental hazards and/or happenings. Thus, it is necessary to provide such trailers with more capabilities that could better ensure the safety of itself and the vehicle (namely, the driver of the vehicle) performing the towing.

It is with respect to these and other general considerations that the following embodiments have been described. Also, although relatively specific problems have been discussed, it should be understood that the embodiments should not be limited to solving the specific problems identified in the background.

### SUMMARY

The features and advantages of the present disclosure will be more readily understood and apparent from the following detailed description, which should be read in conjunction with the accompanying drawings, and from the claims which are appended to the end of the detailed description.

According to various embodiment of the present disclosure, a trailer to be towed by a vehicle may comprise: at least two road wheels; and at least one electro-mechanical braking (EMB) unit attached to one of the at least two road wheels. Wherein the at least one EMB unit is coupled to a processor with a memory, the processor being part of a centralized EMB controller configured to control the EMB unit, and the memory storing instructions that when executed by the processor causes the at least one EMB unit to perform operations for controlling lateral motion of the trailer. The operations comprising: obtaining first braking instructions from a chassis controller of the vehicle, the first braking instructions being based on a current operating state of the at least one EMB unit determined by the chassis controller; and performing the first braking instructions.

The at least one EMB unit is connected to the chassis controller via a controller area network (CAN) bus.

The first braking instructions are further based on a trailer lateral motion detected by the vehicle, the trailer lateral motion being a trailer yaw of the trailer and the first braking instructions are performed to mitigate the trailer yaw.

The first braking instructions are further based on a current operating state of another one of the at least one EMB unit of the trailer.

The operations further comprise, by the at least one EMB unit: obtaining vehicle operating data from the chassis controller; using the vehicle operating data to generate second braking instructions different from the first braking instructions; and performing the second braking instructions.

The second braking instructions are generated using an anti-lock braking system (ABS) process.

The second braking instructions are slip mitigation based braking instructions associated with the ABS process.

The ABS process performed by the at least one EMB unit of the trailer is independent of an ABS process performed by the chassis controller for the vehicle.

The trailer comprises a plurality of road wheels, and each of the plurality of road wheels is installed with the least one EMB unit.

The trailer comprises a plurality of road wheels, and only some of the plurality of road wheels are installed with the least one EMB unit.

The first braking instructions are based on self-diagnosis data obtained by the at least one EMB unit, the self-diagnosis data indicating the current operating state of the at least one EMB.

The current operating state comprises data indicating a current braking capability of the at least one EMB unit.

The current braking capability indicates that the at least one EMB unit is unable to apply any braking force on a road wheel of the trailer onto which the at least one EMB unit is installed.

A brake of the at least one EMB unit is in a consistently open position that is unable to apply any of the braking on the road wheel of the trailer onto which the at least one EMB unit is installed.

The current braking capability indicates that the at least one EMB unit is only able to apply a portion of a maximum braking force that the at least one EMB unit is capable of applying onto a road wheel of the trailer onto which the at least one EMB unit is installed.

According to some embodiments of the present disclosure, a method for controlling lateral motion of a trailer attached to a vehicle may comprise: obtaining first braking instructions from a chassis controller of the vehicle, the first braking instructions being based on a current operating state of the at least one EMB unit determined by the chassis controller; and performing the first braking instructions.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 shows a vehicle and a trailer combination according to an exemplary embodiment of the present disclosure.

FIG. 2 shows a data flow diagram illustrating a method for controlling lateral motion and brake distribution of a trailer attached to a vehicle according to an exemplary embodiment of the present disclosure.

FIGS. 3A-3B show flowcharts illustrating methods for controlling lateral motion and brake distribution of a trailer attached to a vehicle according to an exemplary embodiment of the present disclosure.

FIG. 4 shows a block diagram illustrating a data processing system according to an exemplary embodiment of the present disclosure.

FIG. 5 shows a schematic view of a vehicle including a steering system and a brake assembly according to an exemplary embodiment of the present disclosure.

FIG. 6 shows is a perspective schematic view of a vehicle showing a yaw axis and a pitch axis according to an exemplary embodiment of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

References to an “operable connection” or “operably connected” means that a particular device is able to communicate (e.g., send and receive data or the like) with one or more other devices. The devices themselves may be directly connected to one another or may be indirectly connected to one another through any number of intermediary devices, such as in a network topology. The connections between the devices may be wired and/or wireless connections.

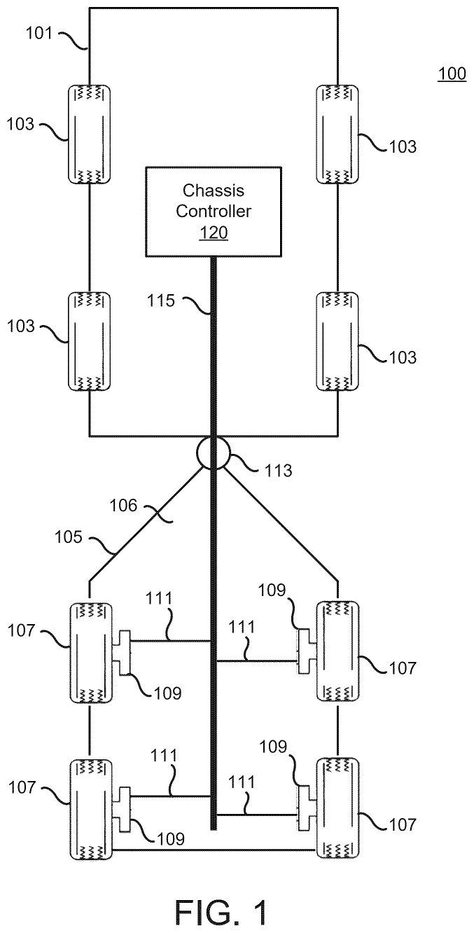

FIG. 1 shows a vehicle and a trailer combination according to an exemplary embodiment of the present disclosure. In particular, a towing system 100 includes a vehicle 101 is shown towing trailer 105 via a mechanical connection 113. Each of these components of towing system 100 are described in more detail below.

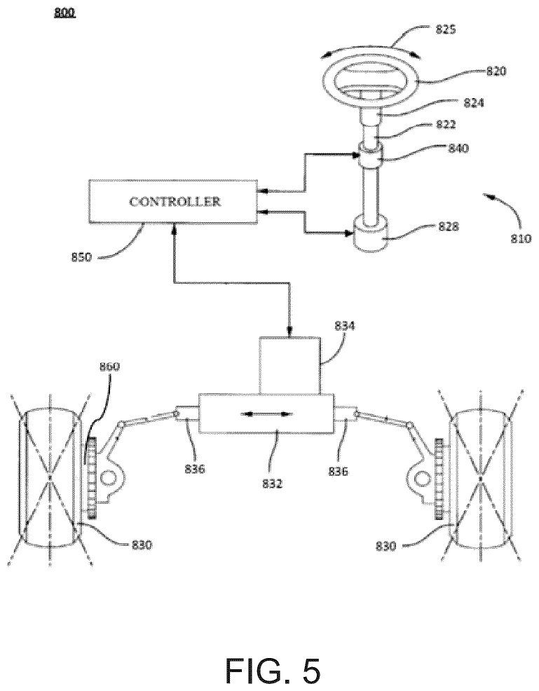

The vehicle 101 may be any type of motor vehicle (e.g., gas, electrical, hybrid, or the like) having at least two axles connected to at least four road wheels 103 (e.g., 830, FIG. 5). For example, the vehicle 101 may be compact car, a sport utility vehicle (SUV), a pickup truck, a semi-truck, or the like.

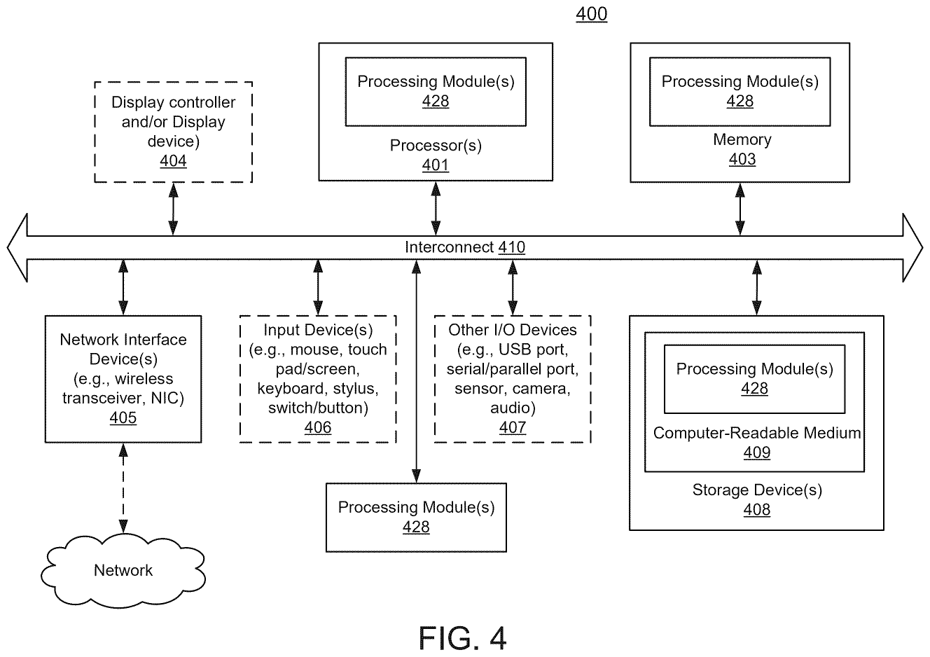

The vehicle 101 may include at least one chassis controller 120 embodied, at least in part by, a computer/computing device (e.g., an embedded computing system for motor vehicles). Additional details of a computing device are discussed in refernce to FIG. 4. In embodiments, the chassis controller 120 may be configured to improve a handling and comfort (e.g., drive comfort) of the vehicle 101 by monitoring (e.g., via one or more sensors installed in the vehicle) and controlling one or more mechanical, electrical, and/or electro-mechanical components (e.g., braking units, motor(s), or the like) installed within the vehicle 101.

The chassis controller 120 may also control other aspects and/or components of the vehicle 101 (e.g., cooling, infotainment, or the like) without departing from the scope of embodiments disclosed herein.

The vehicle 101 may also have one or more mechanical structures (e.g., a hook, a hinge, parts of a ball and hitch assembly, or the like) that forms a part of the mechanical connection 113 connecting the vehicle to the trailer 105.

The trailer 105 may include a trailer body 106 and one or more trailer road wheels 107 installed on the trailer body 106. Opposing ones of the one or more trailer road wheels 107 may be mechanically connected to one another (e.g., using a rotating axle, or the like). The trailer 105 may have any number of the one or more trailer road wheels 107 greater than one. The trailer road wheels 107 may be identical or different from the road wheels 103 of the vehicle.

The trailer 105 may also have one or more mechanical structures (e.g., a hook, a hinge, parts of a ball and hitch assembly, or the like) that forms a corresponding part of the mechanical connection 113 connecting the vehicle to the trailer 105.

Although the specific term “trailer” is used, in the context of one or more embodiments disclosed herein, the term “trailer” can refer to any structure (e.g., a utility trailer, a hauler, tailers for semi-trucks, another motor vehicle 101, or the like) that can be towed behind the vehicle 101. In particular, the term “trailer” should be interpreted as any unpowered vehicle and/or structure that can be towed by vehicle 101 and/or another one of the trailer 105.

In embodiments, the trailer 105 may further include one or more electro-mechanical braking (EMB) units 109. For example, each of the one or more trailer road wheels 107 may include one of the EMB units 109. As another example, at least one of the one or more road wheels may be fitted with one of the EMB units 109.

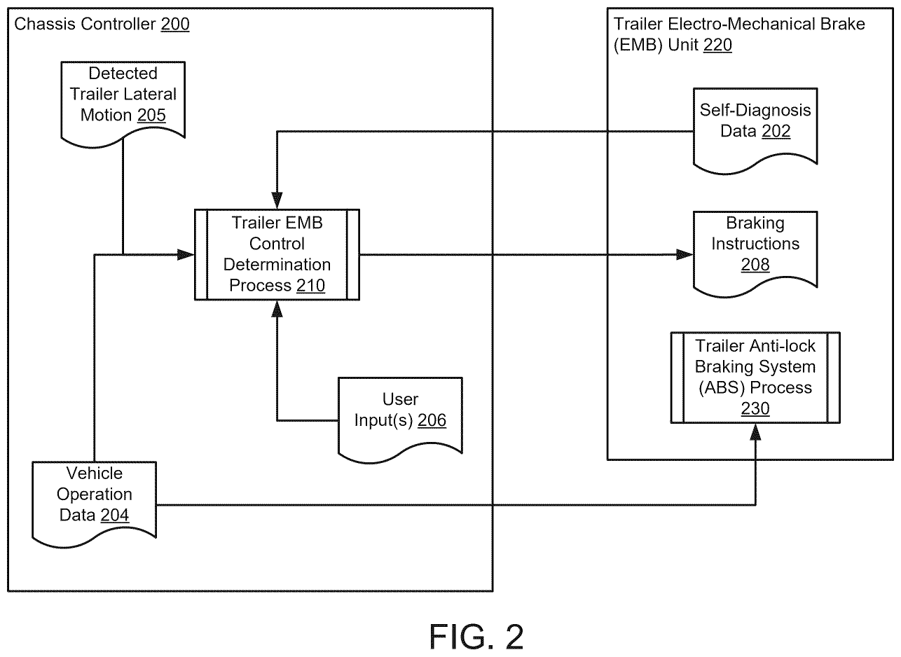

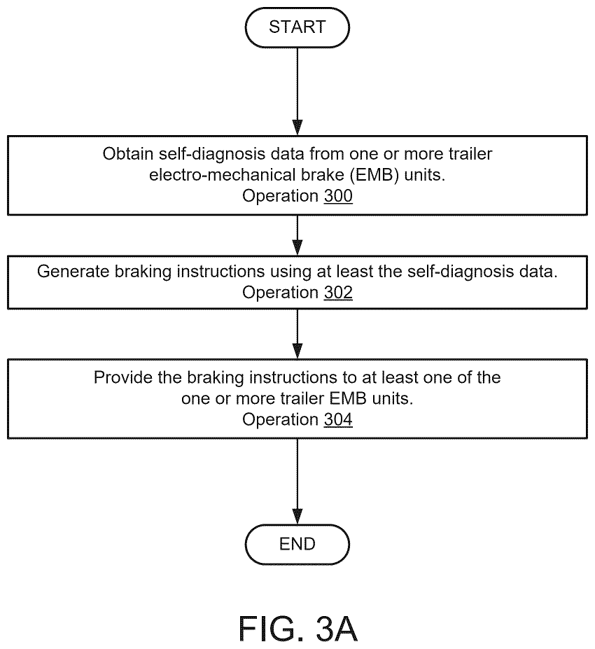

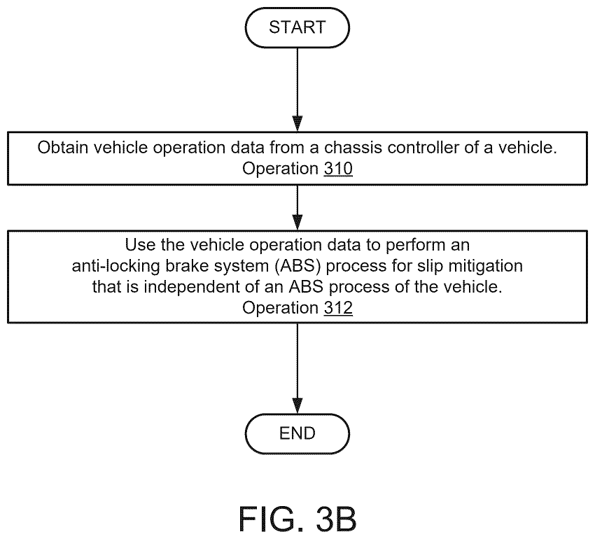

Each of the EMB units 109 may be any type of EMB units that are commonly installed on road wheels of a motor vehicle, and may include any component (e.g., a brake, motor(s) and actuator(s) or the like for electrically controlling the brake, an embedded controller or the like including at least a processor with memory for controlling the motor(s) and actuator(s), one or more sensors, or the like) commonly associated with EMB units. In embodiments, each EMB unit 109 may be implemented as, but is not limited to: a disk brake EMB; a drum brake EMB; an electromagnet coupled to an EMB unit 109; or the like. Each EMB units 109 may include an electrical control unit (ECU) (e.g., an embedded controller, or the like) comprising at least a processor with a memory that is configured to control each respective EMB unit 109 to perform one or more braking operations (e.g., to perform the methods discussed below in reference to FIGS. 2-3B). Alternatively, a single ECU (e.g., an EMB ECU) may be configured to control more than one EMB unit 109 (e.g., the trailer 105 may have: a single EMB ECU configured as a centralized EMB ECU that controls all EMB units 109 installed on the trailer 105; one EMB ECU that controls two or more (but not all) of the EMB units 109 installed on the trailer 105; or any combination of ECUs and EMB units 109 thereof).

Each of the EMB units 109 may be electrically coupled to the chassis controller 120 of the vehicle 101 via a serial connection bus 115 (e.g., a controller area network (CAN) bus, or the like). Each of the EMB units 109 may be operably coupled to the serial connection bus 115 via a connector 111 (e.g., one or more jumpers, cables, wires, or the like).

Although the vehicle 101 and trailer 105 are shown in FIG. 1 as having only a few components, the vehicle 101 and trailer 105 may include other components (e.g., any of the components discussed below in FIG. 5, any component commonly associated with motor vehicle and trailer, or the like) without departing from the scope of embodiments disclosed herein. The components included and the number of each component may be based, in part, on a choice of a manufacturer (or either the vehicle 101 or the trailer 105) and/or a function of trailer towing capacity required by an operator (e.g., driver) of the vehicle 101.

Turning now to FIG. 2, FIG. 2 shows a data flow diagram illustrating a method for controlling lateral motion and brake distribution of a trailer attached to a vehicle according to an exemplary embodiment of the present disclosure.

In this diagram, flows of data and processing of data are illustrated using different sets of shapes. A first set of shapes (e.g., 202, 204, 205, 206, 208, etc.) is used to represent data structures (e.g., files, documents, data packets, or the like), a second set of shapes (e.g., 210, 230, etc.) is used to represent processes performed using and/or that generate data, and a third set of shapes (e.g., 200, 220, etc.) is used to represent components that perform the processes depicted suing the second set of shapes. The data flow diagram of FIG. 2 may be performed by any of the computing-related/computing-enabled components (namely, chassis controller 120 and EMB units 109) shown in FIG. 1.

As shown in FIG. 2, trailer EMB unit 220 (e.g., 109, FIG. 1) may obtain self-diagnosis data 202. The self-diagnosis data 202 may include any type of data that indicates a current state and/or performance capability/level (e.g., braking capability) of the trailer EMB unit 220. For example, the self-diagnosis data 202 may indicate that the trailer EMB unit 220 is in a failed state where a brake (e.g., mechanical brake) of the trailer EMB unit 220 is in a continuously open (e.g., consistently open) state and cannot be operated to apply braking force to a road wheel of the trailer (e.g., 105, FIG. 1) on which the trailer EMB unit 220 is installed.

As another example, the self-diagnosis data 202 may indicate that the trailer EMB unit 220 is in a different failed state where the trailer EMB unit 220 is only able to apply a part of its maximum rated (e.g., manufacture rated maximum) braking force (e.g., 10%, 20%, 99%, or any number under 100%) (also referred to herein as “maximum braking force”).

Any other type of data indicative of a current state and/or performance capability/level of the trailer EMB unit 220 may be included as the self-diagnosis data 202 without departing from the scope of embodiments disclosed herein. The self-diagnosis data 202 may also be obtained in any way by any of the components (e.g., sensors, embedded controller, or the like) of the trailer EMB unit 220.

In embodiments, the self-diagnosis data 202 obtained by the trailer EMB unit 220 may be communicated (e.g., transmitted, provided, or the like) to the chassis controller 200 via the serial connection bus 115 discussed in reference to FIG. 1.

As further shown in FIG. 2, the chassis controller 200 (e.g., 120, FIG. 1) may obtain vehicle operation data 204, detected trailer lateral motion 205, and user input(s) 206.

Vehicle operation data 204 may be any type of data indicative of a current operation (e.g., movement, mechanical and/or electrical state, or the like) of a motor vehicle (e.g., 101, FIG. 1) in which the chassis controller 200 is installed. For example, the vehicle operation data 204 may include, but is not limited to: a speed of the vehicle; an acceleration (e.g., longitudinal acceleration or the like) of the vehicle; a deceleration (e.g., longitudinal deceleration or the like) of the vehicle; a lateral motion (e.g., sway, yaw, lateral acceleration, lateral deceleration, or the like) of the vehicle; a wheel speed of one or more of the road wheels (e.g., 103, FIG. 1); a position of one or more of the road wheels; or the like. The vehicle operation data 204 may be detected (e.g., obtained, sensed, or the like) using any sensor (or combination of sensors) installed in the vehicle 101.

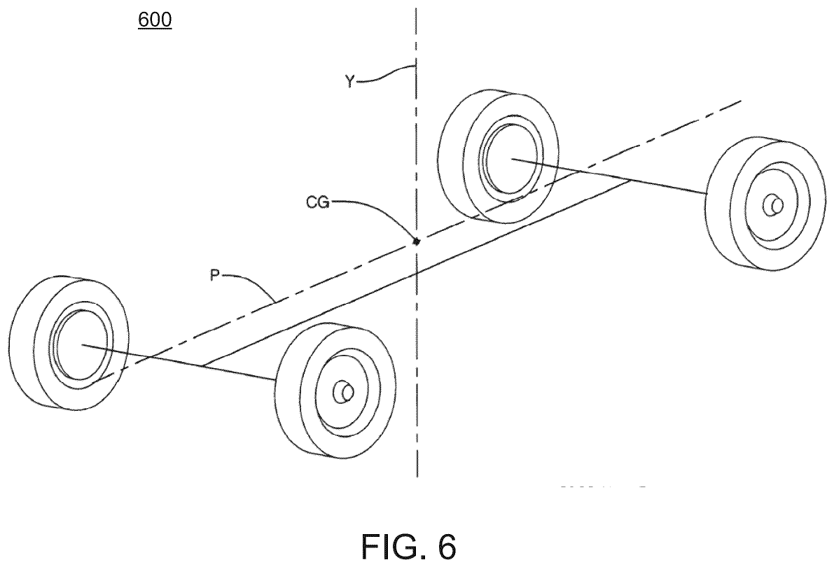

Detected trailer lateral motion 205 may be any type of data indicative of a lateral motion (e.g., sway, yaw, trailer yaw, or the like) (see, e.g., FIG. 6 explaining lateral motion of a vehicle/trailer) of the trailer 105. The detected trailer lateral motion 205 may be detected (e.g., obtained, sensed, or the like) using any sensor (or combination of sensors) installed on the vehicle 101 and/or on the trailer 105.

User input(s) 206 may include any type of manual input provided by a driver of the vehicle 101. The manual inputs may include, but are not limited to: application of the brakes of the vehicle (e.g., a user brake input); turning on/off any functions and/or features of the vehicle such as slip prevention (e.g., using an anti-lock braking system (ABS) process/system of the vehicle), traction control, or the like; steering input; or the like.

In embodiments, because the trailer 105 is connected (e.g., being towed by) the vehicle 101, if the trailer 105 is experiencing lateral acceleration (or any other type of movement and/or motion), then the vehicle 101 is also experiencing some lateral acceleration. Such movement and/or motion induced by the trailer 105 may also be indicated in any one of the detected trailer lateral motion 205 and/or the vehicle operation data 204.

Additionally, if any of the trailer EMB unit 220 has completely failed (e.g., loses power, enters a state where it can no longer transmit data to the chassis controller 200, loses connection with the chassis controller, or the like where the chassis controller 200 is no longer able to detect the existence of the trailer EMB unit 220), the chassis controller 200 may use the signals on the serial connection bus 115 to determine that the trailer EMB unit 220 has completely failed. For example, the chassis controller 200 may be configured to monitor signals (e.g., data) from the trailer EMB unit 220 at a predetermined interval/rate (e.g., every 2 seconds, 10 seconds, or any suitable amount of time set by a manufacturer of the chassis controller 200). If the chassis controller 200 determines that the trailer EMB unit 220 has failed to provide the signals (e.g., data) at the predetermined interval/rate, the chassis controller 200 can mark the trailer EMB unit as being in the completely failed state.

As further shown in FIG. 2, the self-diagnosis data 202, the detected trailer lateral motion 205, the vehicle operation data 204, and the user input(s) 206 may all (or partially) be provided to (e.g., ingested and used by) trailer EMB control determination process 210 of chassis controller 200.

More specifically, chassis controller 200 may perform EMB control determination process 210 using any or all of the data included in self-diagnosis data 202, the detected trailer lateral motion 205, the vehicle operation data 204, and the user input(s) 206 to control a braking of the trailer EMB unit 220 (or any other ones of the trailer EMB unit 220 installed on the trailer 105).

In particular, based on a movement/motion of the vehicle 101 and/or the trailer 105 indicated within the collection of data, the chassis controller 200 may generate (e.g., using trailer EMB control determination process 210) braking instructions 208 for any of the trailer EMB units 220 installed on the trailer 105.

Such braking instructions 208 may be used, for example, to: eliminate trailer yaw (e.g., trailer sway) caused by a lateral motion of the trailer 105; synchronize the braking of the trailer 105 and the vehicle 101; adjust for one or more failed trailer EMB units 220 (e.g., adjust the braking of done by one or more of the trailer EMB units 220 based on current operating states of at least one of other ones of the trailer EMB units 220); or the like.

For example, assume that the trailer 105 includes only a single axle connected to two trailer road wheels 107. Both trailer road wheels 107 are installed with one of the trailer EMB unit 220 and the trailer EMB unit 220 of the left road wheel has failed (completely or partially). The braking instructions 208 would include instructions/commands that take such failure into consideration (e.g., instructions/commands that cause the non-failed trailer EMB unit 220 on the right road wheel to perform the majority of the braking.

As another example, assume again that the trailer 105 includes only a single axle connected to two trailer road wheels 107 that each have a trailer EMB unit 220. The braking instructions 208 may include instructions/commands to reduce or cancel a braking force applied by at least one of the trailer EMB units 220 so that trailer yaw is not created by the trailer 105.

As yet another example, assume that the trailer 105 now has two or more axles and that each road wheel connected to these axles have a trailer EMB unit 220. Additionally, if one of these trailer EMB units 220 fail (completely or partially), the braking instructions 208 may include instructions/commands for the other 3 trailer EMB units 220 to control a movement/motion (e.g., eliminate yaw, control braking, or the like) of the trailer 105 (e.g., the attitude of the trailer 105 as discussed below in reference to FIG. 6).

As yet another example, the braking instructions 208 (when performed by the trailer EMB unit(s) 220) may cause the trailer EMB unit(s) 220 to respond to the chassis controller's commands (e.g., sent over via the serial connection bus 115). More specifically, if the trailer moves left the chassis controller 200 may sense the disturbance (e.g., in the form of detected trailer lateral motion 205 and/or vehicle operation data 204) as the acceleration of the vehicle 101 will not match the model for a given steering wheel position. The chassis controller 200 would then send a command (e.g., braking instructions 208) to one or more right side trailer EMB units 220 to apply slight braking pressure to mitigate the left movement of the trailer 105. The reverse (i.e., trailer moved right, EMB braking applied on left) can also be achieved using the same process.

As a result, trailer-related movements/motion (e.g., trailer yaw, which can be destabilizing and dangerous to the vehicle 101 towing the trailer 105 when near trailer weight limits and highway speeds are involved; or the like), can be advantageously prevented, mitigated, and/or eliminated using the braking instructions 208 generated by chassis controller 200 using trailer EMB control determination process 210.

As further shown in FIG. 2, chassis controller 200 may also transmit (e.g., via the serial connection bus 115) the vehicle operation data 204 to (any of) the trailer EMB unit(s) 220. Upon reception, the trailer EMB unit(s) 220 may use the vehicle operation data 204 to perform a trailer ABS process 230. In particular, the trailer EMB unit(s) 220 may use any of the data included in the vehicle operation data 204 to perform the trailer's 105 own ABS (e.g., slip mitigation, or the like) processes. Such ABS processes performed by the trailer EMB unit(s) 220 may be independent of an ABS process performed by the chassis controller 200 to control a slip of the vehicle 101.

Additionally, as part of trailer ABS process 230, each trailer EMB unit 220 installed on the trailer 105 may generate ABS-related braking instructions (e.g., different from braking instructions 208) (also referred to herein as “slip mitigation-based braking instructions”) that are transmitted to each of the other trailer EMB units 220 (e.g., via connectors 111) such that all of the trailer EMB units 220 can be synched up properly to perform the trailer's own independent ABS processes (e.g., slip mitigation for the trailer 105 itself, or the like).

Any of the processes illustrated using the second set of shapes (shown in FIG. 2) may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Turning to FIGS. 3A-3B, a flowcharts illustrating methods for controlling lateral motion and brake distribution of a trailer in accordance with one or more embodiments are shown. The methods may be performed, for example, by any of the components of the vehicle 101 and/or trailer 105 of FIG. 1, and/or other components not shown therein.

Starting with FIG. 3A, FIG. 3A shows a method for controlling one or more EMB unit (e.g., 109, FIG. 1) by, for example, the chassis controller 120 of FIG. 1.

At Operation 300, as discussed above in reference to FIG. 2, the chassis controller may obtain self-diagnosis data (e.g., 202, FIG. 2) from one or more trailer EMB units (e.g., 220, FIG. 2). The self-diagnosis data may be transmitted by the trailer EMB unit(s) to chassis controller using a serial connection bus (e.g., 115, FIG. 1) that operably connects the trailer EMB unit(s) to the chassis controller.

At Operation 302, as discussed above in reference to FIG. 2 (namely in reference to the descriptions related to trailer EMB control determination process 210), the chassis controller may generate braking instructions (e.g., 208, FIG. 2) using the self-diagnosis data. The braking instructions may also be based on vehicle operation data (e.g., 204, FIG. 2), detected trailer lateral motion (e.g., 205, FIG. 2), and/or user input(s) (e.g., 206, FIG. 2) obtained by the chassis controller.

At Operation 304, as discussed above in reference to FIG. 2, the chassis controller may provide the braking instructions to at least one of the one or more trailer EMB units. Upon receipt of the braking instructions, the one or more trailer EMB units may apply (e.g., perform) the braking instructions.

The method of FIG. 3A may end following operation 304.

Turning now to FIG. 3B, FIG. 3B shows a method for one or more trailer EMB units to apply their own lateral control and braking distribution (e.g., their own independent ABS processes) using data obtained from a chassis controller of a vehicle that is towing the trailer.

At Operation 310, as discussed above in reference to FIG. 2, one or more of the trailer EMB units may obtain (e.g., receive) vehicle operation data (e.g., 204, FIG. 2) from the chassis controller of the vehicle.

At Operation 312, as discussed above in reference to FIG. 2 (namely in reference to the descriptions related to trailer ABS process 230), the one or more of the trailer EMB units that obtained the vehicle operation data may use the vehicle operation data to perform one or more ABD processes for slip mitigation (or the like) that is independent of an ABS process performed by the chassis controller of the vehicle.

The method of FIG. 3B may end following operation 312.

Any of the chassis controller 120 and/or the EMB units 109 may include and/or be implemented with one or more computing devices (e.g., a vehicle-based computing system, a vehicle-based data processing system, or the like). Turning to FIG. 4, a block diagram illustrating an example of a data processing system (e.g., a computing device) in accordance with an embodiment is shown. For example, system 400 may perform any of the processes or methods described above in refernce to FIGS. 2 and 3A-3B. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations.

Note further that system 400 is intended to show a generic computing device that can be applied and/or adapted to any environment (e.g., within a vehicle as a vehicle-based computing system). Although the components of system 400 are described at a high level of generality, each of these components may have their vehicle-environment equivalents without departing from the scope of embodiments disclosed herein. Said another way, any of the components shown in FIG. 4 may be a version specifically adapted to be used in vehicles (e.g., motor vehicles).

System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, a vehicle's embedded computing system, or any combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-408 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like.

More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets.

Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device.

For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, vehicle embedded computing systems, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

Any of the vehicle 101 and/or the trailer 105 according to certain exemplary embodiments of the present disclosure may be identical, or substantially similar to, vehicle 800 shown in FIG. 5. The vehicle 800 may be any passenger or commercial automobile such as a hybrid vehicle, an electric vehicle, or any other type vehicles. FIG. 5 is a schematic view of a vehicle 800 including a steering system and a brake assembly according to an exemplary embodiment of the present disclosure. The vehicle 800 may include a steering system 810 for use in a vehicle. The steering system 810 can allow a driver or operator of the vehicle 800 to control the direction of the vehicle 800 or road wheels 830 of the vehicle 800 through the manipulation of a steering wheel 820. The steering wheel 820 is operatively coupled to a steering shaft (or steering column) 822. The steering wheel 820 may be directly or indirectly connected with the steering shaft 822. For example, the steering wheel 820 may be connected to the steering shaft 822 through a gear, a shaft, a belt and/or any connection means. The steering shaft 822 may be installed in a housing 824 such that the steering shaft 822 is rotatable within the housing 824.

The road wheels 830 may be connected to knuckles, which are in turn connected to tie rods. The tie rods are connected to a steering assembly 832. The steering assembly 832 may include a steering actuator motor 834 and steering rods 836. The steering rods 836 may be operatively coupled to the steering actuator motor 834 such that the steering actuator motor 834 is adapted to move the steering rods 836. The movement of the steering rods 836 controls the direction of the road wheels 830 through the knuckles and tie rods.

One or more sensors 840 may be configured to detect position, angular displacement or travel 825 of the steering shaft 822 or steering wheel 820, as well as detecting the torque of the angular displacement. The sensors 840 provide electric signals to a controller 850 indicative of the angular displacement and torque 825. The controller 850 sends and/or receives signals to/from the steering actuator motor 834 to actuate the steering actuator motor 834 in response to the angular displacement 825 of the steering wheel 820.

In the steer-by-wire steering system, the steering wheel 820 may be mechanically isolated from the road wheels 830. For example, the steer-by-wire system has no mechanical link connecting the steering wheel 825 from the road wheels 830. Accordingly, the steer-by wire steering system may comprise a feedback actuator or steering feel actuator 828 comprising an electric motor which is connected to the steering shaft or steering column 822. The feedback actuator or steering feel actuator 828 provides the driver or operator with the same “road feel” that the driver receives with a direct mechanical link.

Although the embodiment illustrated in FIG. 5 shows the vehicle 800 having the steer-by-wire steering system, the vehicle 800 may alternatively have a mechanical steering system without departing from embodiments disclosed herein. The mechanical steering system typically includes a mechanical linkage or a mechanical connection between the steering wheel 820 and the road wheels 830. In the mechanical steering system, the steering actuator motor 834 includes an electric motor to provide power to assist the movement of the road wheels 830 in response to the operation of the driver or a control signal of the controller 850. Accordingly, the electric motor can be used as the steering actuator motor 834 or can be included in the feedback actuator or steering feel actuator 828.

The electric motor can also be employed in an electromagnetic brake assembly 860. The electromagnetic brake assembly 860 is configured to cause the road wheel 830 to slow or stop motion using electromagnetic force to apply mechanical resistance or friction by using the torque generated by the electric motor.

FIG. 6 shows is a perspective schematic view of a vehicle showing a yaw axis and a pitch axis. The yaw axis Y is perpendicular to a horizontal plane extending through the center of gravity CG of a vehicle 600 (e.g., any of the vehicle 101 and/or the trailer 105). An attitude (e.g., motion, change in movement, or the like) of the vehicle 600 includes the position, or change in position over time of the vehicle 600 about the yaw axis Y. In other words, the attitude of the vehicle 600 will change relative to the yaw axis Y if the vehicle 600 is turning or is in a rotational spin (e.g., experiencing the trailer yaw phenomenon). The pitch axis P extends thought the center of gravity CG of the vehicle 600, perpendicular to the yaw axis Y and parallel to the horizontal plane. The attitude of the vehicle 600 further includes the position, or change in position over time of the vehicle 600 about the pitch axis P. In other words, the attitude of the vehicle 600 will change relative to the pitch axis P if the vehicle 600 is rolling from side to side. It is important for the chassis controller 120 to detect (e.g., using one or more pieces of sensed data discussed in reference to FIG. 2) a change in the attitude of the vehicle 600 to predict a critical swaying (e.g., side to side swaying) condition that may lead to an accident. The chassis controller 120 utilizes the same information to determine when it is necessary to apply the braking system(s) (e.g., EMB units 109) of the trailer 105, independently of or in coordination with the brakes of the vehicle 101, to help stabilize the trailer 105. It is contemplated that the chassis controller 120 may apply the braking system(s), even when an operator of the vehicle 101 does not directly apply the braking system(s) on the trailer 105 and/or the vehicle 101.

Although the example embodiments have been described in detail, it should be understood that various changes, substitutions and alterations can be made herein without departing from the spirit and scope of the application as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

What is claimed is:

1. A trailer to be towed by a vehicle, the trailer comprising:
at least two road wheels; and
at least one electro-mechanical braking (EMB) unit attached to one of the at least two road wheels, wherein the at least one EMB unit is coupled to a processor with a memory, the processor being part of a centralized EMB controller configured to control the EMB unit, and the memory storing instructions that when executed by the processor causes the at least one EMB unit to perform operations for controlling lateral motion of the trailer, the operations comprising:
obtaining first braking instructions from a chassis controller of the vehicle, the first braking instructions being based on a current operating state of the at least one EMB unit determined by the chassis controller; and
performing the first braking instructions.

2. The trailer of claim 1, wherein the at least one EMB unit is connected to the chassis controller via a controller area network (CAN) bus.

3. The trailer of claim 2, wherein the first braking instructions are further based on a trailer lateral motion detected by the vehicle, the trailer lateral motion being a trailer yaw of the trailer and the first braking instructions are performed to mitigate the trailer yaw.

4. The trailer of claim 3, wherein the first braking instructions are further based on a current operating state of another one of the at least one EMB unit of the trailer.

5. The trailer of claim 1, wherein the operations further comprise, by the at least one EMB unit:
obtaining vehicle operating data from the chassis controller;
using the vehicle operating data to generate second braking instructions different from the first braking instructions; and
performing the second braking instructions.

6. The trailer of claim 5, wherein the second braking instructions are generated using an anti-lock braking system (ABS) process.

7. The trailer of claim 6, wherein the second braking instructions are slip mitigation based braking instructions associated with the ABS process.

8. The trailer of claim 7, wherein the ABS process performed by the at least one EMB unit of the trailer is independent of an ABS process performed by the chassis controller for the vehicle.

9. The trailer of claim 1, wherein the trailer comprises a plurality of road wheels, and each of the plurality of road wheels is installed with the least one EMB unit.

10. The trailer of claim 1, wherein the trailer comprises a plurality of road wheels, and only some of the plurality of road wheels are installed with the least one EMB unit.

11. The trailer of claim 1, wherein the first braking instructions are based on self-diagnosis data obtained by the at least one EMB unit, the self-diagnosis data indicating the current operating state of the at least one EMB.

12. The trailer of claim 11, wherein the current operating state comprises data indicating a current braking capability of the at least one EMB unit.

13. The trailer of claim 12, wherein the current braking capability indicates that the at least one EMB unit is unable to apply any braking force on a road wheel of the trailer onto which the at least one EMB unit is installed.

14. The trailer of claim 13, wherein a brake of the at least one EMB unit is in a consistently open position that is unable to apply any of the braking on the road wheel of the trailer onto which the at least one EMB unit is installed.

15. The trailer of claim 12, wherein the current braking capability indicates that the at least one EMB unit is only able to apply a portion of a maximum braking force that the at least one EMB unit is capable of applying onto a road wheel of the trailer onto which the at least one EMB unit is installed.

16. A method for controlling lateral motion of a trailer attached to a vehicle, the method being performed by at least one electro-mechanical braking (EMB) unit of the trailer and comprising:
obtaining first braking instructions from a chassis controller of the vehicle, the first braking instructions being based on a current operating state of the at least one EMB unit determined by the chassis controller; and
performing the first braking instructions.

17. The method of claim 16, wherein the at least one EMB unit is connected to the chassis controller via a controller area network (CAN) bus.

18. The method of claim 17, wherein the first braking instructions are further based on a trailer lateral motion detected by the vehicle, the trailer lateral motion being a trailer yaw of the trailer and the first braking instructions are performed to eliminate the trailer yaw.

19. The method of claim 18, wherein the first braking instructions are further based on a current operating state of another one of the at least one EMB unit of the trailer.

20. The method of claim 16, further comprising:
obtaining vehicle operating data from the chassis controller;
using the vehicle operating data to generate second braking instructions different from the first braking instructions; and
performing the second braking instructions.
